(19) United States
(12) Patent Application Publication
(10) Pub. No.: US 2026/0148084 A1
(43) Pub. Date: May 28, 2026

(54) METHOD, APPARATUS, AND RECORDING MEDIUM FOR GENERATING CUSTOMIZED ROBOT MODEL USING ARTIFICIAL INTELLIGENCE

(71) Applicant: Vision Space, Seoul (KR)

(72) Inventor: Wonseok Choi, Seongnam-si (KR)

(73) Assignee: Vision Space, Seoul (KR)

(21) Appl. No.: 19/227,418

(22) Filed: Jun. 3, 2025

Related U.S. Application Data
(63) Continuation-in-part of application No. 18/963,312, filed on Nov. 27, 2024.

(30) Foreign Application Priority Data
Nov. 26, 2024 (KR) 10-2024-0170916
Dec. 27, 2024 (KR) 10-2024-0197961

(51) Int. Cl. G06N 3/092; G06N 3/042; G06N 3/045

(52) U.S. Cl. CPC G06N 3/092; G06N 3/042; G06N 3/045

(57) ABSTRACT

In a method for generating a customized robot model using artificial intelligence, the method is performed by an electronic apparatus, and comprises receiving data including information regarding a robot model to be generated by a user, wherein the data includes data in two or more forms among a text form, an image form, an audio form, and a video form, generating a plurality of robot models that conform to the information based on an artificial intelligence multimodal model, evaluating physical properties of the generated robot models using GNN (Graph Neural Network) and PINN (Physics-Informed Neural Network), selecting a customized robot model that most conforms to the information among the generated robot models based on the evaluation, training the customized robot model through reinforcement learning, and outputting the customized robot model in a universal robot data format.

### CROSS-REFERENCE TO RELATED APPLICATION

This application is based on and claims the benefit of priority to Korean Patent Application No. 10-2024-0170916 filed Nov. 26, 2024, Korean Patent Application No. 10-2024-0197961 filed Dec. 27, 2024, and U.S. patent application Ser. No. 18/963,312 filed Nov. 27, 2024, the aforementioned priority applications being hereby incorporated by reference in their entirety.

### TECHNICAL FIELD

The present disclosure relates to a method, apparatus, and recording medium for generating a customized robot model using artificial intelligence, and more particularly, to a method, apparatus, and recording medium for generating a customized robot model by utilizing an artificial intelligence multimodal model, and technologies such as a Graph Neural Network (GNN) and a Physics-Informed Neural Network (PINN).

### BACKGROUND

The field of robotics is rapidly advancing, and the integration of Artificial Intelligence (AI) is significantly enhancing the capabilities and adaptability of robots. However, the process of developing and training robot models using AI remains challenging. In particular, generating large-scale datasets for effective training and building robot models customized for various tasks and environments requires considerable time and effort.

Conventional robot learning largely relies on manually collecting and processing data. This is not only time-consuming but can also limit the quantity and quality of data. Furthermore, data collected from real-world environments can be noisy and incomplete, which can lead to a decline in model performance. Additionally, robot learning can utilize various types of data, such as text, images, 3D models, and sensor data. However, existing methods struggle to effectively integrate and utilize these diverse data types. In particular, leveraging information contained in text data for robot actions or task planning is not easy.

Designing and manufacturing robots is a complex and time-consuming process. Traditional methods require significant human expertise and manual work to design the robot's structure, select appropriate components, and ensure that the robot meets specific task requirements. This can be inefficient and costly, especially when customized robot solutions are needed for various applications. Furthermore, generating customized robot models optimized for each task and environment is difficult. Existing robot models are often designed for specific tasks or environments, making it challenging to apply them to other tasks or environments. Modifying robot models or adding new functionalities according to user requirements is also not straightforward.

On the other hand, a “digital twin” is a virtual replica of a real-world physical asset, system, or process, and it can be used in the field of robotics to simulate the behavior of actual robots, test them in various environments, and train artificial intelligence models.

### SUMMARY

In this regard, the technical problem to be solved by the present disclosure is to provide a method for efficiently generating user-customized robot models using artificial intelligence technology, accurately evaluating their physical properties, and training the generated robot models.

Conventional methods of generating robot models involve experts directly designing and manufacturing them, which requires a significant amount of time and cost. Furthermore, there have been difficulties in producing customized robot models that reflect user requirements. In particular, developing robot models that satisfy user requirements in various aspects, such as the robot's appearance, functions, and movements, has been a very complex and demanding task.

Moreover, there have been limitations in accurately evaluating and verifying the physical properties of robot models. Conventional simulation-based evaluation methods often suffer from poor accuracy due to differences from the real-world environment, and methods of manufacturing and evaluating actual robots involve high time and costs, as well as the potential for safety issues. In addition, regarding the training of robot models, there have been difficulties in generating training data that accurately matches the user's intended purpose and performing the training.

According to embodiments for achieving the object of the present disclosure, a method for generating a customized robot model using artificial intelligence, the method being performed by an electronic apparatus, comprises: receiving data including information regarding a robot model to be generated by a user, wherein the data includes data in two or more forms among a text form, an image form, an audio form, and a video form, generating a plurality of robot models that conform to the information based on an artificial intelligence multimodal model, evaluating physical properties of the generated robot models using GNN (Graph Neural Network) and PINN (Physics-Informed Neural Network), selecting a customized robot model that most conforms to the information among the generated robot models based on the evaluation, training the customized robot model through reinforcement learning, and outputting the customized robot model in a universal robot data format.

In one embodiment of the present disclosure, the receiving the data may include receiving data in a form of a prompt for an artificial intelligence language model.

In one embodiment of the present disclosure, the generating the robot models may include considering a past search history of the user.

In one embodiment of the present disclosure, the reinforcement learning may include policy-based reinforcement learning using PPO (Proximal Policy Optimization) algorithm.

In one embodiment of the present disclosure, the reinforcement learning may include parallel multi-agent reinforcement learning.

In one embodiment of the present disclosure, the training the customized robot model through reinforcement learning may include training the customized robot model with data based on domain randomization.

In one embodiment of the present disclosure, the method may further comprise receiving feedback on the training from the customized robot model and training the artificial intelligence multimodal model.

In one embodiment of the present disclosure, the method may further comprise normalizing an image of the customized robot model using a ViT (Vision Transformer) model.

In one embodiment of the present disclosure, the universal robot data format may be the Unified Robot Description Format (URDF).

In one embodiment of the present disclosure, the method may further include providing feedback to the artificial intelligence multimodal model with the customized robot model.

In one embodiment of the present disclosure, the method may further include simulating the customized robot model in a digital twin environment.

In one embodiment of the present disclosure, the method may further include debugging the customized robot model in a digital twin environment.

According to embodiments for achieving the object of the present disclosure, an electronic apparatus comprises: one or more processors; and one or more memories storing at least one instruction executable by the one or more processors, wherein the one or more processors are configured to, by executing the at least one instruction: receive data including information regarding a robot model to be generated by a user, wherein the data includes data in two or more forms among a text form, an image form, an audio form, and a video form, generate a plurality of robot models that conform to the information based on an artificial intelligence multimodal model, evaluate physical properties of the generated robot models using GNN (Graph Neural Network) and PINN (Physics-Informed Neural Network), select a customized robot model that most conforms to the information among the generated robot models based on the evaluation, train the customized robot model through reinforcement learning, and output the customized robot model in a universal robot data format.

According to embodiments for achieving the object of the present disclosure, a non-transitory computer-readable recording medium storing at least one instruction that, when executed by one or more processors, causes the one or more processors to perform operations, wherein the operations comprise: receiving data including information regarding a robot model to be generated by a user, wherein the data includes data in two or more forms among a text form, an image form, an audio form, and a video form, generating a plurality of robot models that conform to the information based on an artificial intelligence multimodal model, evaluating physical properties of the generated robot models using GNN (Graph Neural Network) and PINN (Physics-Informed Neural Network), selecting a customized robot model that most conforms to the information among the generated robot models based on the evaluation, training the customized robot model through reinforcement learning, and outputting the customized robot model in a universal robot data format.

### BRIEF DESCRIPTION OF THE DRAWINGS

Embodiments will be more clearly understood from the following detailed description taken in conjunction with the accompanying drawings in which:

FIG. 1 is a block diagram illustrating an apparatus for generating a robot model dataset and a customized robot model using artificial intelligence according to embodiments of the present disclosure.

FIG. 2 is a flowchart illustrating a method for generating a robot model dataset using artificial intelligence according to embodiments of the present disclosure.

FIG. 3 is a diagram for explaining some steps of the method of FIG. 2.

FIG. 4 is a diagram for explaining other steps of the method of FIG. 2.

FIG. 5A is a diagram for explaining the step of embedding multimodal robot data in the method of FIG. 2.

FIGS. 5B and 5C are diagrams for explaining the step of generating a robot model dataset in the method of FIG. 2.

FIG. 6 is a flowchart illustrating a method for generating a customized robot model using artificial intelligence according to embodiments of the present disclosure.

FIG. 7 is a diagram illustrating an example of a customized robot model according to the method of FIG. 6.

FIG. 8 is a diagram for explaining the step of training a customized robot model in the method of FIG. 6.

### DETAILED DESCRIPTION

Hereinafter, embodiments will be described in detail with reference to the accompanying drawings. However, various modifications may be made to the embodiments, so the scope of the patent application is not limited or restricted by these embodiments. It should be understood that all changes, equivalents, and substitutions to the embodiments are included in the scope of rights.

Specific structural or functional descriptions of the embodiments are disclosed for illustrative purposes only and may be implemented in various forms. Therefore, the embodiments are not limited to specific disclosed forms, and the scope of this specification includes changes, equivalents, or substitutions included in the technical spirit.

The terms used in the embodiments are used for descriptive purposes only and should not be interpreted as limiting.

Unless defined otherwise, all terms used herein, including technical or scientific terms, have the same meaning as commonly understood by one of ordinary skill in the art to which the embodiments belong. Terms such as those defined in commonly used dictionaries should be interpreted as having meanings consistent with their meanings in the context of the relevant art, and should not be interpreted in an idealized or overly formal sense unless explicitly defined in this application.

Terms such as first or second may be used to describe various components, but these terms should only be interpreted as distinguishing one component from another. For example, a first component may be named a second component, and similarly, a second component may also be named a first component.

When an element is referred to as being “connected” to another element, it should be understood that it can be directly connected or coupled to the other element, or that other elements may be present in between.

The singular expression includes the plural expression unless the context clearly indicates otherwise. Conversely, the plural expression includes the singular expression unless the context clearly indicates otherwise. In this specification, the expressions “each of a plurality of A” may refer to each of all elements included in the plurality of A, or may refer to each of some elements of the plurality of A. In this specification, the expression “one or more A” may mean a set of one or more A, unless the context clearly indicates otherwise.

The expression “configured to ˜” used in this specification may have meanings such as “set to ˜”, “having the ability to ˜”, “changed to ˜”, “made to ˜”, “capable of ˜” depending on the context. This expression is not limited to “specially designed in hardware”, and for example, a processor configured to perform a specific operation may mean a general-purpose processor capable of performing that operation through software execution, or a special-purpose computer structured through programming to perform that specific operation.

In this specification, terms such as “include” or “have” are intended to designate the presence of features, numbers, steps, operations, components, parts, or combinations thereof described in the specification, and do not preclude the possibility of the presence or addition of one or more other features, numbers, steps, operations, components, parts, or combinations thereof.

Also, in describing with reference to the accompanying drawings, the same reference numerals will be given to the same constituent elements regardless of the drawing reference numerals, and redundant descriptions thereof will be omitted. However, the omission of such description is not intended to imply that the corresponding constituent element is not included in a specific embodiment. In describing the embodiments, if it is determined that specific descriptions of related known technologies may unnecessarily obscure the gist of the embodiments, the detailed descriptions thereof will be omitted.

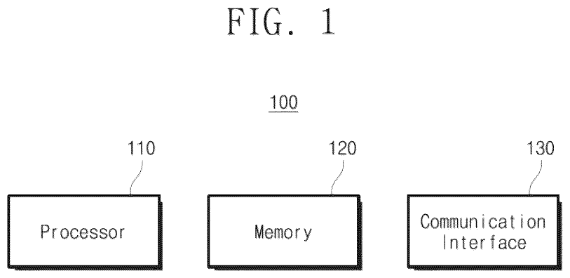

FIG. 1 is a block diagram illustrating an apparatus for generating a robot model dataset and a customized robot model using artificial intelligence according to embodiments of the present disclosure.

Referring to FIG. 1, an electronic apparatus 100 according to embodiments of the present disclosure is an apparatus for generating a robot model dataset and a customized robot model using artificial intelligence.

The electronic apparatus 100 may be a server device. In this case, a service provider may be an operating entity that provides a service for generating a robot model dataset and a customized robot model using artificial intelligence according to the present disclosure. The electronic apparatus 100 communicates with a user device (not shown) through a communication network (not shown) and can perform a method for generating a robot model dataset and a customized robot model using artificial intelligence according to the present disclosure.

The server device may include various types of servers. For example, the server device may include various types of servers such as a centralized server, a cloud server, a distributed server, a virtual environment server, an edge server, a multi-tenant server, or a combination thereof, and each server may be implemented physically or logically. In addition, the server device may implement a dedicated server optimized for a specific function, a general-purpose server, or an integrated system thereof. However, this is merely an example, and the present disclosure is not limited thereto.

The user device may be a device of a user who uses the service for generating a robot model dataset and a customized robot model using artificial intelligence according to the present disclosure described above. For example, the user device may include a smartphone, a tablet computer, a PC (Personal Computer), a mobile phone, a PDA (Personal Digital Assistant), a wearable device, etc., but the present disclosure is not limited thereto.

In this specification, when describing the configuration or operation of a device, the term “device” is a term for referring to the device being described, and the term “external device” may be used as a term for referring to a device existing outside from the perspective of the device being described. For example, when describing a server device as a “device”, a user device may be referred to as an “external device” from the perspective of the server device.

The communication network may include a wired communication network or a wireless communication network. For example, the wired communication network may include a communication network according to a method such as USB (Universal Serial Bus), HDMI (High Definition Multimedia Interface), and the wireless communication network may include a communication network according to a method such as eMBB (enhanced Mobile Broadband), URLLC (Ultra Reliable Low-Latency Communications), MMTC (Massive Machine Type Communications), LTE (Long-Term Evolution), GSM (Global System for Mobile communications), CDMA (Code Division Multiple Access), WCDMA (Wideband CDMA), WiBro (Wireless Broadband), WiFi (Wireless Fidelity), Bluetooth, NFC (Near Field Communication), GPS (Global Positioning System), but the present disclosure is not limited thereto.

Referring back to FIG. 1, the electronic apparatus 100 includes a processor 110, a memory 120, and a communication interface 130. At least one of the components of the electronic apparatus 100 may be omitted, or other components may be added to the electronic apparatus 100, or additionally or alternatively, some of the components may be integrated and implemented, or implemented as a single or plural entity. At least some of the components inside or outside the electronic apparatus 100 may be connected to each other through a bus, GPIO (General Purpose Input/Output), SPI (Serial Peripheral Interface), or MIPI (Mobile Industry Processor Interface), etc., thereby giving or receiving data or signals.

The processor 110 may include one or more processors. The processor 110 can drive software (e.g., instructions, programs, etc.) to control at least one component of the electronic apparatus connected to the processor 110. The processor 110 can read data from or write data to the memory 120. In addition, the processor 110 can perform various operations such as calculation, processing, data generation, or manipulation according to the embodiments of the present disclosure by executing at least one instruction stored in the memory 120. The processor 110 can also read data from or write data to the memory 120.

The processor 110 may include a CPU (Central Processing Unit), a GPU (Graphics Processing Unit), an AP (Application Processor), a mobile AP, a DSP (Digital Signal Processor), an NPU (Neural Processing Unit), an MCU (Microcontroller Unit), an FPGA (Field-Programmable Gate Array), etc., but the present disclosure is not limited thereto.

The memory 120 may include one or more memories. The memory 120 can write or read various data according to requests from the processor 110, etc. The memory 120 can store at least one instruction executed by the processor 110.

The memory 120 may include DRAM (Dynamic random access memory), SRAM (Static random access memory), TTRAM (Twin transistor RAM), MRAM, TRAM (Thyristor RAM), Z-RAM (Zero capacitor RAM), EEPROM (Electrically Erasable Programmable Read-Only Memory), flash memory, MRAM (Magnetic RAM), Spin-Transfer Torque MRAM (Spin-Transfer Torque MRAM), Conductive bridging RAM (CBRAM), FeRAM (Ferroelectric RAM), PRAM (Phase change RAM), etc., but the present disclosure is not limited thereto.

In this specification, the expressions “at least one or more instructions stored in the memory 120” or “program stored in the memory 120” may be used to refer to an operating system for controlling the resources of the electronic apparatus 100, an application, or middleware that provides various functions to the application so that the application can utilize the resources of the electronic apparatus 100. In one embodiment, when the processor 110 performs a specific operation, the memory 120 may store instructions that are executed by the processor 110 and correspond to the specific operation.

The communication interface 130 may include one or more communication circuits. The communication interface 130 can perform wired or wireless communication between the electronic apparatus 100 and an external device (e.g., a user device or an electronic apparatus not shown).

The communication interface 130 can perform wired communication according to the methods such as USB, HDMI, etc., or perform wireless communication according to the methods such as eMBB, URLLC, MMTC, etc., but the present disclosure is not limited thereto.

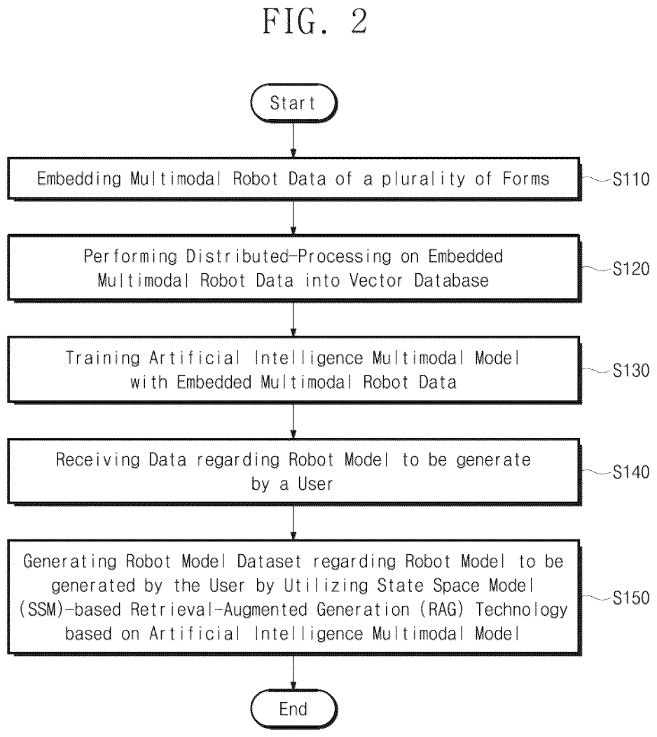

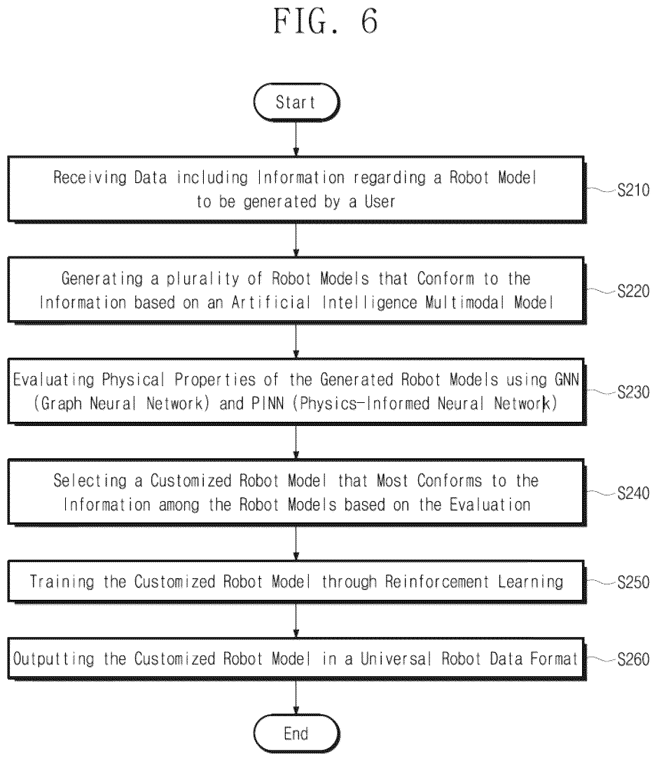

Hereinafter, the method for generating a robot model dataset using artificial intelligence will be described with reference to FIG. 2, and the method for generating a customized robot model using artificial intelligence will be described with reference to FIG. 6.

FIG. 2 is a flowchart illustrating a method for generating a robot model dataset using artificial intelligence according to embodiments of the present disclosure.

Referring to FIGS. 1 and 2, a method for generating a robot model dataset using artificial intelligence according to embodiments of the present disclosure is performed by an electronic apparatus 100 and includes: embedding multimodal robot data in a plurality of forms S110; performing distributed-processing on the embedded multimodal robot data into a vector database S120; training an artificial intelligence multimodal model with the embedded multimodal robot data S130; receiving data regarding a robot model to be generated by a user S140; and generating a robot model dataset regarding the robot model to be generated by the user by utilizing SSM-based Retrieval-Augmented Generation (RAG) technology based on the artificial intelligence multimodal model S150.

The method for generating a robot model dataset using artificial intelligence according to embodiments of the present disclosure may be performed in a digital twin environment that virtually implements the reality in which an actual robot is implemented.

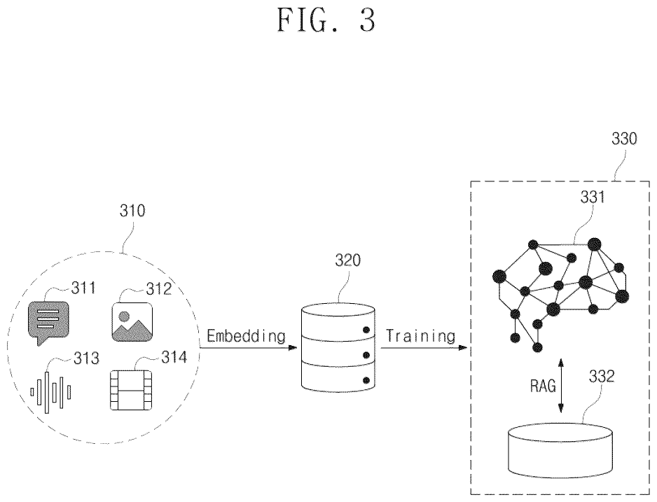

FIG. 3 is a diagram for explaining some steps of the method of FIG. 2. Specifically, FIG. 3 is a diagram for explaining steps S110 to S130 of the method of FIG. 2.

Referring to FIGS. 2 and 3, a method for generating a robot model dataset using artificial intelligence according to embodiments of the present disclosure includes embedding multimodal robot data in a plurality of forms S110.

“Modality” is a way of expressing or conveying information, and “multimodal” means using various modalities together. Multimodal data refers to data in which various forms of information such as text, images, audio, and video are combined.

The multimodal robot data 310 according to embodiments of the present disclosure may include, for example, data in a text form 311, an image form 312, an audio form 313, a video form 314, and the like. For example, the multimodal robot data 310 may include data in two or more forms among the above forms. For example, the multimodal robot data 310 in the text form 311 may be text data describing a robot, the multimodal robot data 310 in the image form 312 may be photograph or drawing data of a robot, the multimodal robot data 310 in the audio form 313 may be voice data containing a description of a robot, and the multimodal robot data 310 in the video form 314 may be video data showing a robot operating. However, the present disclosure is not limited to the embodiments disclosed herein.

For example, the multimodal robot data 310 may be robot-related data collected for training an artificial intelligence multimodal model to be described later. Alternatively, the multimodal robot data 310 may be data input by a user as data regarding a robot model to be generated by the user.

For example, the “OpenCLip ViT-G/14 model”, which is an artificial intelligence model, can be used for the embedding. Since this model can embed both text and images into a shared vector space, the electronic apparatus 100 can simultaneously process and retrieve these modalities. For example, if a user searches for “a robot arm that grabs a box”, the electronic apparatus 100 can retrieve relevant information from the text description and an image of a robot arm performing the grabbing motion. This feature is important for efficiently identifying and retrieving relevant information from a database containing various data types.

According to this embodiment, by embedding multimodal robot data consisting of various forms, a multimodal search system for robot data can be implemented.

The embedding multimodal robot data in a plurality of forms S110 may further include adding three-dimensional embedding based on the embedded multimodal robot data. Specifically, if the embedded multimodal robot data is in a text form or an image form (two-dimensional), three-dimensional embedding can be added based on this. Including three-dimensional data allows for a more comprehensive representation of the robot model and the operating environment. By integrating three-dimensional information, the electronic apparatus 100 can generate more accurate robot models, perform more accurate searches, and provide more relevant recommendations.

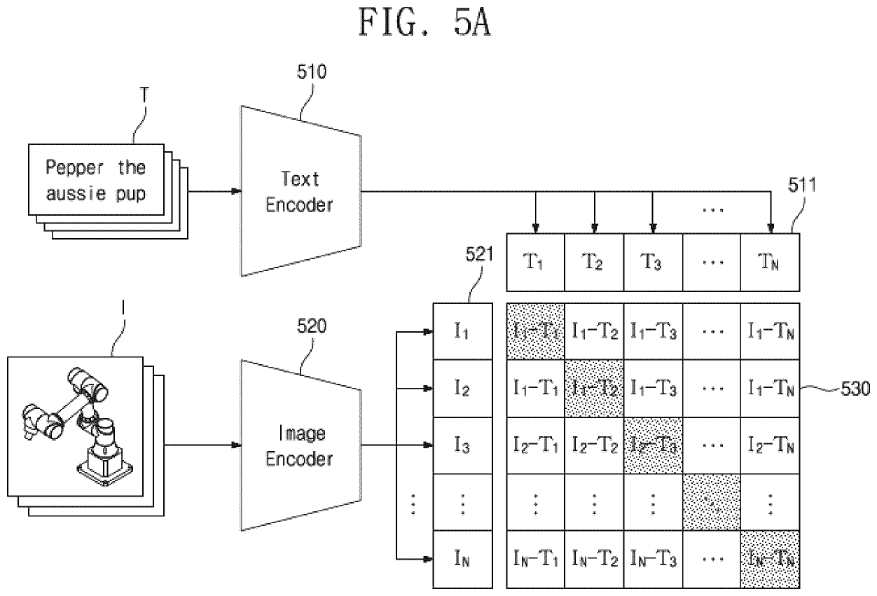

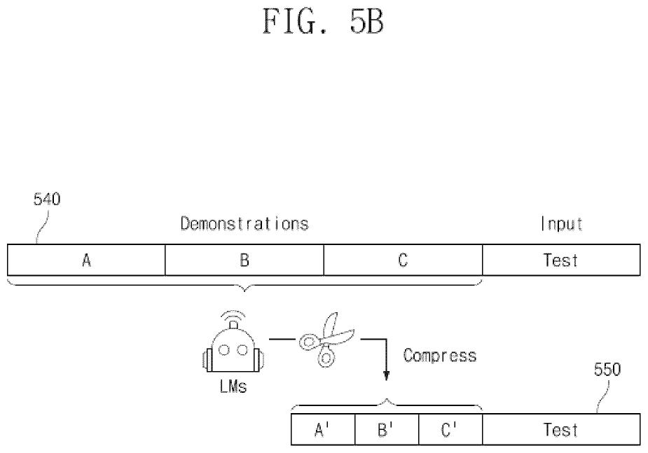

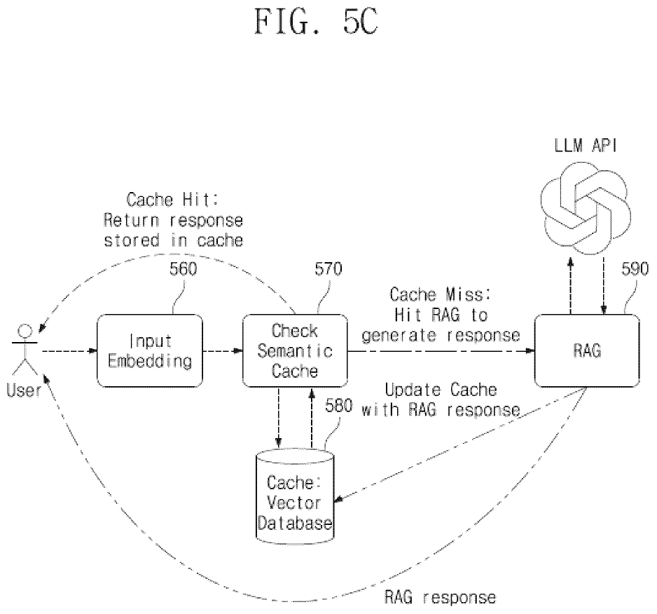

Hereinafter, step S110 will be described in detail with reference to FIG. 5A.

FIG. 5A is a diagram for explaining embedding multimodal robot data in the method of FIG. 2. Specifically, FIG. 5A is a diagram for explaining embedding when the multimodal robot data is in a text form and an image form.

Referring to FIGS. 2, 3, and 5A, a text encoder 510 and an image encoder 520 can each map data in a text form T and data in an image form I to an embedding space of the same dimension. In this embedding space, the text embedding vector 511 and the image embedding vector 521 can be compared with each other to calculate semantic similarity therebetween.

For example, for data in a text form T such as “Pepper the aussie pup”, the text encoder 510 analyzes it and converts it into text embedding vectors 511 T₁, T₂, T₃, . . . , T_{N} containing meaning. For data in an image form I regarding a robot, the image encoder 520 analyzes it and converts it into image embedding vectors 521 I₁, I₂, I₃, . . . , I_{N} containing visual features. Multimodal data embedded into vectors in this way is located in the same space, making them comparable. That is, it becomes possible to calculate the semantic similarity between the text “Pepper the aussie pup” and an image regarding a robot.

In the present disclosure, semantic relationships between text and images can be learned by using a multimodal embedding model that represents text and image data in a single space.

Referring back to FIGS. 2 and 3, a method for generating a robot model dataset using artificial intelligence according to embodiments of the present disclosure includes performing distributed-processing on the embedded multimodal robot data into a vector database S120.

Specifically, distributed-processing into a vector database 320 can be performed on the multimodal robot data 310 embedded in step S110. For example, to efficiently process and utilize multimodal robot data in various forms, the present disclosure utilizes multimodal embedding and vector database technologies, and in this process, cloud-based solutions such as AWS Athena, a serverless interactive query service, Apache Spark, an integrated analysis engine for big data processing, and Amazon SageMaker can be actively utilized. By storing data in a vector database, the electronic apparatus 100 can efficiently retrieve similar or related data points based on vector representations.

First, multimodal robot data can be stored in cloud storage such as Amazon S3, and AWS Athena can be used to access the multimodal robot data stored in S3 and extract necessary data through SQL queries. This can simplify the data preprocessing process and allow for efficient management of data in various formats.

Next, distributed-processing of large-scale multimodal robot data can be performed using Apache Spark. By distributing data across multiple nodes and processing it in parallel, Apache Spark can enable the multimodal embedding process using text encoders, image encoders, etc., to be performed quickly. Amazon SageMaker helps in building and managing such distributed learning environments and can further improve the learning speed of multimodal embedding models by utilizing GPU instances.

The embedding vectors generated in this way represent information of different forms, such as text and image data, in a single space, allowing for the understanding of semantic relationships between data and the measurement of similarity. Subsequently, the embedded multimodal robot data can be stored in a vector database. A vector database is a database specialized in efficiently storing and retrieving high-dimensional vector data, and it can distribute and store large-scale multimodal robot data across multiple nodes using distributed-processing technology and quickly retrieve it through parallel processing.

Referring back to FIGS. 2 and 3, a method for generating a robot model dataset using artificial intelligence according to embodiments of the present disclosure includes training an artificial intelligence multimodal model with the embedded multimodal robot data S130.

Specifically, an artificial intelligence multimodal model 330 can be trained with the multimodal robot data embedded through steps S110 and S120. For example, the artificial intelligence multimodal model 330 may include a Vision-Language Model (VLM) 331.

First, the embedded multimodal robot data can be processed into a form suitable for the VLM 331. Images can be resized, and text can be tokenized and converted into numerical form. The VLM 331 can be trained using this processed data. During the training process, the relationships between various forms of data (e.g., text form and image form) can be identified, and the model can be trained to understand various task instructions and environmental information. The trained model can evaluate its performance using an evaluation dataset and improve performance by adjusting hyperparameters or changing the model structure as needed.

The artificial intelligence multimodal model 330 can augment data by utilizing Retrieval-Augmented Generation (RAG) technology. “Retrieval-Augmented Generation (RAG)” technology is a method of improving the generation capability of a model by utilizing an external knowledge base. In the present disclosure, multimodal robot data (e.g., data for model training) can be augmented by utilizing RAG technology. Specifically, a knowledge base 332 containing various information related to robot models is constructed, and information related to the embedded multimodal data is retrieved from the knowledge base to augment the multimodal robot data.

In the present disclosure, the VLM 331 can augment multimodal robot data through RAG technology by utilizing the knowledge base 332, and the augmented data can be accumulated in the knowledge base 332. The accumulated data can then be used again for training the VLM 331.

According to this embodiment, the problem of data scarcity required for robot model generation is alleviated, and the generalization performance of the model can be significantly improved. Specifically, by utilizing VLMs and fine-tuning techniques specially adapted for the robotics domain, the accuracy and integrity of the data used for robot learning can be ensured. This can help mitigate the “hallucination” problem of large language models (LLMs).

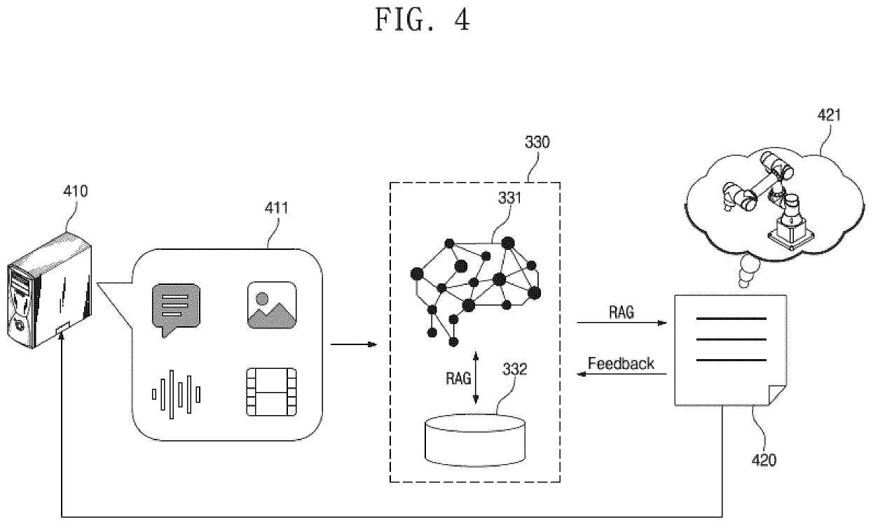

FIG. 4 is a diagram for explaining other steps of the method of FIG. 2. Specifically, FIG. 4 is a diagram for explaining steps S140 to S150 of the method of FIG. 2.

Referring to FIGS. 2 and 4, a method for generating a robot model dataset using artificial intelligence according to embodiments of the present disclosure includes receiving data regarding a robot model to be generated by a user S140.

A user can input data 411 regarding a robot model that they intend to generate through a user device 410. The data 411 regarding the robot model input by the user may be multimodal robot data in a plurality of forms. For example, the data 411 regarding the robot model input by the user may include data in a text form, an image form, an audio form, a video form, etc. For example, the data 411 may include data in two or more forms among the above forms. For example, text form data may be text data describing a robot, image form data may be photograph or drawing data of a robot, audio form data may be voice data containing a description of a robot, and video form data may be video data showing a robot operating. However, the present disclosure is not limited to the embodiments disclosed herein.

The electronic apparatus 100 receives the data 411 regarding the robot model to be generated by the user.

A method for generating a robot model dataset using artificial intelligence according to embodiments of the present disclosure includes generating a robot model dataset 420 regarding the robot model 421 to be generated by the user by utilizing SSM-based Retrieval-Augmented Generation (RAG) technology based on the artificial intelligence multimodal model.

Specifically, in the present disclosure, after receiving the data 411 regarding the robot model to be generated by the user in step S140, a robot model dataset 420 regarding the robot model 421 to be generated by the user can be generated by utilizing SSM (State Space Model)-based Retrieval-Augmented Generation (RAG) technology based on the artificial intelligence multimodal model 330 trained in step S130.

An “SSM (State Space Model)” is a model that describes a system that changes over time, and it is a model that defines the relationship between inputs, outputs, and states using hidden variables that represent the current state of the system. For example, in a system that controls the movement of a robot arm, the current state of the robot arm can be represented by the angles and speeds of the joints. Using an SSM, it is possible to predict the state of the robot arm in the next moment, i.e., the change in the angles and speeds of the joints, through the current state and inputs such as the force applied to the motor. Also, outputs such as the position of the end of the robot arm can be calculated using the current state.

For example, Mamba-3B is a representative SSM-based language model. Existing Transformer models use a method of comparing all words with each other to understand the relationships between words in a sentence. This is like creating a huge network that connects every word in the sentence one by one, which has the problem of exponentially increasing the amount of computation as the sentence becomes longer. On the other hand, Mamba-3B expresses a sentence as a continuous change of hidden states using an SSM. That is, it is a method of sequentially reflecting word information into a hidden state while reading the sentence and predicting the next word using this hidden state. Through this, contextual information can be efficiently conveyed.

Through these features, Mamba-3B can overcome the limitations of existing Transformer models and provide various advantages such as long text processing, fast inference speed, and low memory usage. Mamba-3B can be used for various natural language processing tasks such as text summarization, translation, question answering, text generation, and code generation.

In step S150, a robot model dataset 420 regarding the robot model 421 to be generated by the user can be generated by utilizing SSM (e.g., Mamba-3B)-based Retrieval-Augmented Generation (RAG) technology. The robot model dataset 420 may be multimodal robot data in a plurality of forms. For example, the robot model dataset 420 may include data for training the robot model 421 to be generated by the user. The robot model dataset 420 may include data for evaluating the robot model 421 to be generated by the user. The robot model dataset 420 may include data regarding the structure of the robot model 421 to be generated by the user. The robot model dataset 420 may include data regarding the operation of the robot model 421 to be generated by the user. The robot model dataset 420 may include skill set data of the robot model 421 to be generated by the user.

Step S150 may include augmenting multimodal robot data by utilizing Retrieval-Augmented Generation (RAG) technology. For example, the VLM 331 can generate the robot model dataset 420 through inference using RAG technology. Alternatively, the VLM 331 can augment multimodal robot data using RAG technology and accumulate it in the knowledge base 332.

Although not shown, a method for generating a robot model dataset using artificial intelligence according to embodiments of the present disclosure may further include providing feedback to the artificial intelligence multimodal model 330 with the robot model dataset 420. Furthermore, a method for generating a robot model dataset using artificial intelligence according to embodiments of the present disclosure may further include training the artificial intelligence multimodal model 330 using the robot model dataset 420 and data 411 regarding the robot model to be generated by the user.

A method for generating a robot model dataset using artificial intelligence according to embodiments of the present disclosure may further include providing the generated robot model dataset 420 to the user device 410. For example, the robot model dataset 420 provided to the user device 410 may be in a universal robot data format (e.g., “UDRF (Unified Robot Description Format)”).

FIGS. 5B and 5C are diagrams for explaining generating a robot model dataset in the method of FIG. 2.

Referring to FIGS. 2, 4, and 5B, the generating a robot model dataset S150 according to embodiments of the present disclosure may include reducing the number of generated tokens by using Generation Token Compression technology.

“Generation Token Compression” technology is a token sequence compression technology used to reduce the size of text data generated by a language model. A language model (LM) can predict the next token based on previous tokens and sequentially generate text. At this time, the generated token sequence can be represented as A, B, C, etc., as shown in the upper part 540 of FIG. 5B. However, such a generated token sequence can be long, requiring a large amount of storage space and processing time. To solve this problem, a compression algorithm can be used to compress the sequence by removing redundant or predictable information from the generated token sequence. For example, frequently occurring word sequences such as “the”, “a”, “is” can be replaced with short codes, or duplicate tokens can be removed by predicting the next token using contextual information. The lower part 550 of FIG. 5B represents the compressed token sequence as A′, B′, C′, etc. The compressed sequence is shorter than the original sequence but contains the same information. If necessary, a decompression algorithm can be used to restore the compressed token sequence to the original sequence.

According to this embodiment, the efficiency of the language model can be improved and storage space and processing time can be saved by using such a generation token compression technology. The compression algorithm effectively compresses the token sequence using various compression techniques, and the optimal technique can be selected by considering the compression rate and decompression speed. As a result, the inference speed, learning process, and response time of Retrieval-Augmented Generation (RAG) are significantly accelerated, enabling timely recommendations.

Referring to FIGS. 2, 4, and 5C, the generating a robot model dataset S150 according to embodiments of the present disclosure may include reusing existing responses by using Semantic Caching technology.

“Semantic Caching” technology is a technology that improves the efficiency of a language model by storing and reusing previously processed information. Rather than simply storing input text, it is a technology that analyzes the meaning of the text and stores the result to quickly answer similar questions.

When a user asks a question to a language model, the language model can first analyze the meaning of the question. At this time, instead of simply storing the question text as it is, the meaning of the question is understood and embedded in the form of a vector or graph 560 and stored in the cache memory 580. When a new question comes in, the language model can search the cache memory for questions with similar meaning 570. If it is a question similar to a previously answered question, there is no need to generate an answer again, and the answer stored in the cache memory 580 is provided directly to the user (Cache Hit). This can shorten the response time and reduce the computational load of the language model. Conversely, if a similar question is not found in the cache memory 580, the language model analyzes the question and generates a new answer (Cache Miss). At this time, Retrieval-Augmented Generation (RAG) technology can be used to generate the answer 590, and the generated answer can be provided to the user (RAG response). The generated answer is stored in the cache memory 580 and can be used when a similar question comes in next time.

According to this embodiment, by increasing the efficiency of the language model through semantic caching technology, response time can be shortened, computational costs can be reduced, and more user requests can be processed.

In addition, although not shown, a method for generating a robot model dataset using artificial intelligence according to embodiments of the present disclosure may further include detecting data drift of the multimodal robot data and updating the artificial intelligence multimodal model.

“Data drift” is a phenomenon in which the statistical properties of data change over time. In the present disclosure, statistical indicators such as the mean, variance, and correlation of multimodal robot data can be monitored and compared with previous data, and the performance of the artificial intelligence multimodal model can be periodically evaluated to check whether performance degradation occurs. In addition, a model that predicts future data based on past data can be used, or unsupervised learning techniques such as clustering and anomaly detection can be used.

If data drift is detected, the artificial intelligence multimodal model can be updated. For example, techniques such as transfer learning that fine-tunes an existing model to new data, incremental learning that sequentially learns new data, ensemble learning that trains multiple models and combines the results, and active learning that selectively learns data that the model predicts uncertainly can be utilized.

These data drift detection and model update processes can be repeated periodically.

FIG. 6 is a flowchart illustrating a method for generating a customized robot model using artificial intelligence according to embodiments of the present disclosure.

Referring to FIGS. 1 and 6, a method for generating a customized robot model using artificial intelligence according to embodiments of the present disclosure includes: receiving data including information regarding a robot model to be generated by a user S210; generating a plurality of robot models that conform to the information based on an artificial intelligence multimodal model S220; evaluating the physical properties of the generated robot models using GNN and PINN S230; selecting a customized robot model that most closely matches the information among the robot models based on the evaluation S240; training the customized robot model through reinforcement learning S250; and outputting the customized robot model in a universal robot data format S260.

The method for generating a customized robot model using artificial intelligence according to embodiments of the present disclosure may be performed in a digital twin environment that virtually implements the reality in which an actual robot is implemented.

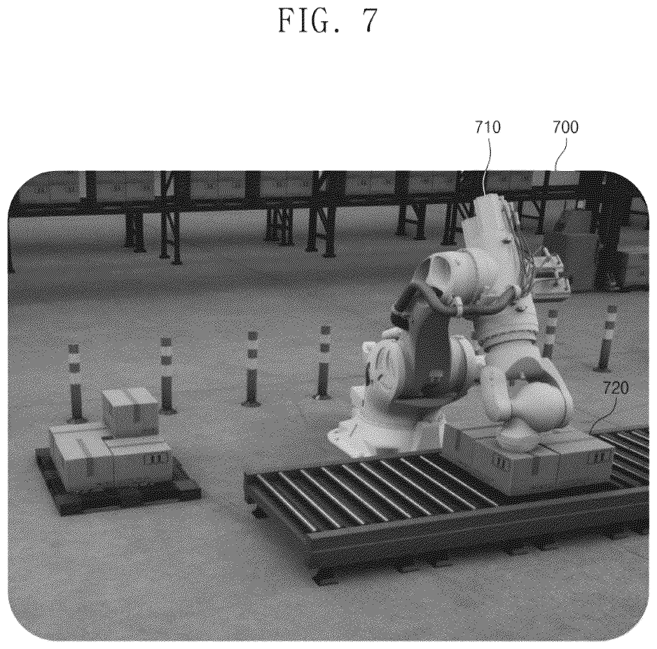

FIG. 7 is a diagram illustrating an example of a customized robot model according to the method of FIG. 6.

Referring to FIGS. 1, 6, and 7, a user may intend to generate a robot model 710 as shown in FIG. 7. The robot model 710 to be generated by the user may be a robot model in a digital twin environment 700. For example, the robot model 710 to be generated by the user may be a robot model that performs an operation of picking up an object 720 from a conveyor belt and loading it onto a pallet.

The method for generating a customized robot model using artificial intelligence according to embodiments of the present disclosure includes receiving data including information regarding a robot model to be generated by a user S210.

The receiving data including information regarding a robot model to be generated by a user S210 may include receiving data in the form of a prompt for an artificial intelligence language model. For example, the receiving data including information regarding a robot model to be generated by a user S210 may include receiving data through a conversational interface such as a chatbot.

The data including information regarding a robot model to be generated by a user may be multimodal data. For example, the data may include data in a text form, an image form, an audio form, a video form, etc. For example, the data may include data in two or more forms among the above forms. For example, the user can input a phrase describing the robot model 710 to be generated. The user can input an image regarding the robot model 710 to be generated. However, the present disclosure is not limited to the embodiments disclosed herein.

Although not shown, a method for generating a customized robot model using artificial intelligence according to embodiments of the present disclosure may further include extracting key information about the characteristics of the robot model to be generated from the data including information regarding the robot model to be generated by the user. The extraction can be performed through natural language processing.

Although not shown, a method for generating a customized robot model using artificial intelligence according to embodiments of the present disclosure may further include providing additional questions through a conversational interface if the information regarding the robot model to be generated by the user is unclear despite the user's input. The additional questions may be about information that cannot be extracted from the user's input up to that point.

The method for generating a customized robot model using artificial intelligence according to embodiments of the present disclosure includes generating a plurality of robot models that conform to the information based on an artificial intelligence multimodal model S220.

In the generating a plurality of robot models that conform to the information based on an artificial intelligence multimodal model S220, a plurality of robot models can be generated according to the method for generating a robot model dataset using artificial intelligence shown in FIG. 2. For example, as shown in FIGS. 2 to 4, a robot model dataset can be generated using an artificial intelligence multimodal model, and a plurality of robot models can be generated based on this. Specifically, the plurality of robot models can be constructed based on the robot model dataset. For example, the plurality of robot models can be constructed based on data regarding the structure of the robot model, data regarding the operation of the robot model, robot model skill set data, and the like.

The generating a plurality of robot models that conform to the information based on an artificial intelligence multimodal model S220 may include considering the user's past search history.

Specifically, an AI-Agent (e.g., CrewAI) can be used to analyze data such as the user's past search history or preferences to generate a customized robot model optimized for the user. For example, the content frequently searched by the user in a conversational interface such as a chatbot can be analyzed. First, the user's data is collected and analyzed to understand the user's interests, behavior patterns, preferred robot functions, etc., and based on this information, the most suitable robot model for the user can be designed.

The method for generating a customized robot model using artificial intelligence according to embodiments of the present disclosure includes evaluating the physical properties of the generated robot models using GNN (Graph Neural Network) and PINN (Physics-Informed Neural Network) S230.

“GNN (Graph Neural Network)” is a deep learning model specialized in processing graph-structured data. A graph is a structure composed of nodes and edges, and it is used to represent various data such as social networks, molecular structures, and knowledge graphs. A GNN learns by updating information about each node through interaction with its neighboring nodes. Each node aggregates information about itself and its neighboring nodes in an initial state and updates its own state based on this. This process is repeated multiple times to learn the information of the entire graph.

“PINN (Physics-Informed Neural Network)” is a deep learning model that directly integrates physical laws into neural network learning. While existing neural networks perform only data-based learning, PINNs learn by utilizing both data and physical laws. A PINN learns by including physical laws in the loss function. That is, the prediction results of the neural network are learned to well satisfy the physical laws. Through this, accurate predictions can be made based on physical laws even in situations where data is insufficient.

In the present disclosure, to accurately evaluate the physical properties of a robot when generating a robot model, GNN and PINN can be utilized to efficiently evaluate the physical properties of the robot.

Specifically, by utilizing a GNN, the structure of the robot can be represented in a graph form to learn the connection relationships and interactions between each component. For example, in the case of a robot arm, a graph can be constructed by representing each joint and link as nodes and edges. The GNN can analyze this graph structure to predict the kinematic characteristics of the robot, i.e., range of motion, degrees of freedom, singularities, etc. In addition, the GNN can calculate the dynamic characteristics of the robot, i.e., forces, torques, accelerations, etc., and evaluate the stability and controllability of the robot.

By utilizing a PINN, the physical laws of the robot can be directly integrated into the neural network to predict the behavior of the robot. By reflecting the robot's equations of motion, material properties, environmental conditions, etc., in the learning process of the PINN, the movement of the actual robot can be accurately simulated. For example, when a robot moves along a specific path, the PINN can calculate the forces and torques acting on each part of the robot and predict the robot's movement. The PINN can be utilized in the robot's design stage to evaluate various design variations and find the optimal design.

By combining GNN and PINN, the physical properties of the robot can be evaluated more accurately and efficiently. The GNN learns the structural characteristics of the robot, and the PINN can predict the behavior of the robot based on physical laws. By combining the advantages of these two technologies, they can be utilized in various fields such as robot design, control, and optimization. For example, in the design stage of a robot arm, the range of motion and degrees of freedom of the arm can be analyzed using a GNN, and the strength and durability of the arm can be evaluated using a PINN. Also, in the robot control process, the movement of the robot can be predicted using GNN and PINN, and the optimal control strategy can be established.

The method for generating a customized robot model using artificial intelligence according to embodiments of the present disclosure includes training the customized robot model through reinforcement learning S250.

The customized robot model selected in step S240 can be trained through reinforcement learning to operate effectively in a real environment or a digital twin environment.

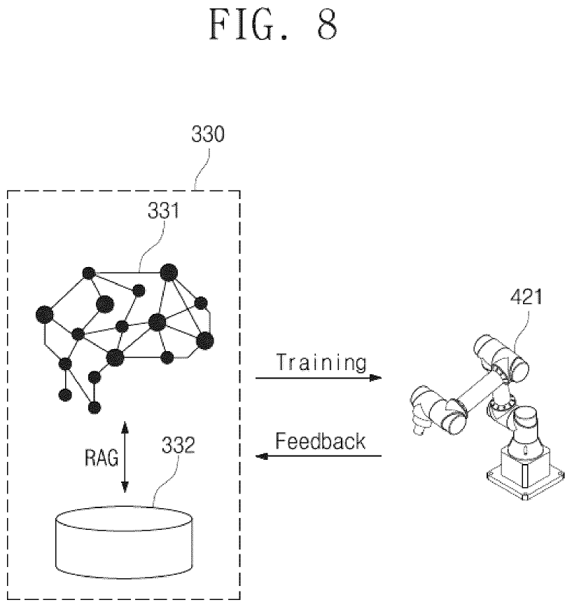

FIG. 8 is a diagram for explaining the training a customized robot model in the method of FIG. 6. Specifically, FIG. 8 is a diagram for explaining step S250 of the method of FIG. 6.

The artificial intelligence multimodal model 330 according to the present disclosure can train the customized robot model 421. The artificial intelligence multimodal model 330 can utilize Retrieval-Augmented Generation (RAG) technology in relation to the training of the customized robot model 421. For example, the artificial intelligence multimodal model 330 can generate training data through RAG technology. The basic operating principle of the artificial intelligence multimodal model 330 is the same as shown in FIGS. 3 and 4.

For example, in step S250, the robot model can be trained through policy-based reinforcement learning utilizing the PPO (Proximal Policy Optimization) algorithm. That is, the robot model can be trained in a way that learns a policy for determining what action the robot will take in a given state. By limiting the difference between the existing policy and the new policy, the learning process can be stabilized, and efficient learning can be enabled. In this case, the robot model can learn the optimal action policy through trial and error using the PPO algorithm. For example, if we assume that the robot is learning the task of grasping an object, using the PPO algorithm, the robot will try to grasp the object in various ways and receive rewards for successful actions and penalties for failed actions. By repeating this process, the robot learns the optimal policy for grasping the object.

For example, in step S250, the learning speed can be increased and performance in various environments can be improved by simultaneously training multiple robot models through parallel multi-agent reinforcement learning. That is, the robot model can be trained in a way that performs reinforcement learning simultaneously in multiple robots or simulation environments. In this case, multiple robots proceed with learning simultaneously in their respective environments and share the experience gained through this, enabling faster and more efficient learning than learning with a single robot.

For example, in step S250, the robot model can be trained in various environments by utilizing a domain randomization technique. That is, the robot model can be trained using a technique that randomly changes the physical properties of the simulation environment, the shape and position of objects, lighting, etc., to increase the diversity of training data. Through domain randomization, the robot model becomes robust to various environmental changes and acquires the ability to operate stably even in real environments. For example, if we assume that the robot is learning the task of grasping a cup, by applying domain randomization, the robot can be trained by randomly changing the size, shape, color, position, lighting conditions, etc., of the cup, and through this, the robot learns the ability to grasp various types of cups.

In addition, a method for generating a customized robot model using artificial intelligence according to embodiments of the present disclosure may further include receiving feedback on training from the customized robot model 421 and training the artificial intelligence multimodal model. By feeding back the experiences and knowledge gained by the robot model through reinforcement learning to the artificial intelligence multimodal model, the model can be improved, and a more effective customized robot model can be generated.

According to this embodiment, the customized robot model trained through reinforcement learning is designed to perform operations optimized according to user requirements and can operate stably in various environments.

The method for generating a customized robot model using artificial intelligence according to embodiments of the present disclosure includes outputting the customized robot model in a universal robot data format S260. For example, the universal robot data format may be UDRF (Unified Robot Description Format). The outputted universal robot data format can be provided to the user in various ways.

In addition, although not shown, a method for generating a customized robot model using artificial intelligence according to embodiments of the present disclosure may further include providing feedback from the customized robot model to the artificial intelligence multimodal model. For example, along with the customized robot model, the user's evaluation of the customized robot model can be provided as feedback to the artificial intelligence multimodal model and used as learning data.

In addition, although not shown, a method for generating a customized robot model using artificial intelligence according to embodiments of the present disclosure may further include simulating the customized robot model in a digital twin environment, debugging the customized robot model in a digital twin environment, and the like.

In addition, although not shown, a method for generating a customized robot model using artificial intelligence according to embodiments of the present disclosure may further include normalizing the image of the customized robot model using a ViT (Vision Transformer) model. The ViT (Vision Transformer) model is a deep learning model for image processing and can be effectively utilized for normalizing the image of a robot model. The ViT model divides an image into patch units and processes each patch by converting it into a vector form. Through this process, global features of the image can be identified, and the relationships between objects in the image can be effectively modeled.

According to the embodiments of the present disclosure, by simulating the performance of the robot model in a digital twin environment before it is deployed in a real environment, the user can evaluate the operation and performance of various robot models under various conditions and make necessary adjustments without the risks associated with real testing. Furthermore, the performance of the deployed model can be continuously monitored in the digital twin environment, and feedback for further optimization can be provided based on real data and user feedback. As a result, it enables rapid design iteration, efficient optimization, and customized solutions tailored to specific user needs for robot models.

According to embodiments of the present disclosure, it is possible to generate customized robot models that meet user requirements by utilizing an artificial intelligence multimodal model based on various types of data provided by the user, such as text, images, audio, and video. By automating and streamlining the robot model generation process through artificial intelligence technology and a conversational interface, it is possible to reduce time and costs compared to conventional methods and improve the efficiency of robot model development. Furthermore, by accurately evaluating and verifying the physical properties of the generated robot models using GNNs and PINNs, it is possible to predict the robot's performance in a real-world environment and prevent safety issues. By training the customized robot models through reinforcement learning, it is possible to optimize the robot's performance and increase user satisfaction. Finally, by outputting the generated customized robot model in a universal robot data format, it can be utilized in various robot platforms.

Additionally, by simulating the performance of the robot model in a digital twin environment before it is deployed in a real-world environment, users can evaluate the behavior and performance of various robot models under various conditions and make necessary adjustments without the risks associated with actual testing. Furthermore, it is possible to continuously monitor the performance of the deployed model in the digital twin environment and provide feedback for further optimization based on actual data and user feedback. Consequently, this enables rapid design iteration, efficient optimization, and customized solutions tailored to specific user needs for robot models.

In conclusion, according to the present disclosure, it is possible to significantly contribute to the development of the robot industry by streamlining the process of generating, evaluating, and training user-customized robot models, and by improving the performance and safety of robots.

The methods according to the present disclosure may be computer-implemented methods. In the present disclosure, although each operation of the methods is shown and described in a predetermined order, each operation may be performed in an order that can be arbitrarily combined according to the present disclosure, in addition to being performed sequentially. In one embodiment, at least some of the operations may be performed in parallel, iteratively, or heuristically. The present disclosure does not exclude making changes or modifications to the methods. In one embodiment, at least some of the operations may be omitted, or other operations may be added.

Various embodiments of the present disclosure can be implemented as software recorded on a machine-readable recording medium. The software may be software for implementing the various embodiments of the present disclosure described above. The software can be inferred from the various embodiments of the present disclosure by programmers in the technical field to which the present disclosure belongs. For example, the software may be machine-readable instructions (e.g., code or code segments) or a program. A machine may be a device capable of operating according to instructions called from a recording medium, for example, a computer. In one embodiment, the machine may be an electronic apparatus according to the embodiments of the present disclosure. In one embodiment, the processor of the machine may execute the called instructions to cause the components of the machine to perform functions corresponding to the instructions. In one embodiment, the processor may be the processor of the electronic apparatus according to the embodiments of the present disclosure. The recording medium may mean all kinds of recording media in which data is stored, which can be read by a machine. The recording medium may include, for example, ROM, RAM, CD-ROM, magnetic tape, floppy disk, optical data storage device, etc. In one embodiment, the recording medium may be a memory. In one embodiment, the recording medium may be implemented in a distributed form in a computer system or the like connected to a network. The software may be stored and executed in a distributed manner in a computer system or the like. The recording medium may be a non-transitory recording medium. A non-transitory recording medium means a tangible medium in which data is stored semi-permanently or temporarily, regardless, and does not include a signal that is temporarily propagated.

As described above, those skilled in the art of the technical field of the present disclosure will recognize that the present disclosure can be implemented in various forms without changing its technical principles or essential features. Therefore, it should be understood that the above embodiments are illustrative only and do not limit the scope of the present disclosure. The scope of the present disclosure is defined by the following claims rather than the detailed description, and all modifications or variations derived from the meaning and scope of the claims and their equivalents should be interpreted as being included in the scope of the present disclosure.

The features and advantages described in this specification describe only some, and more additional features and advantages will become apparent to those skilled in the art from the drawings, specification, and claims. In addition, it should be noted that the language used in this specification has been selected for readability and explanation, and has not necessarily been selected for the purpose of limiting or describing the subject matter of the present disclosure.

The description of the above embodiments is presented for illustrative purposes, and it is not intended to limit the scope of the present disclosure to the exact form. Those skilled in the art will understand that various modifications and variations are possible through the disclosure of the present disclosure.

Therefore, the scope of the present disclosure is not limited by the detailed description, but is defined by the claims of this specification. Accordingly, the embodiments of the present disclosure are illustrative and do not limit the scope of the present disclosure as described in the claims below.

What is claimed is:

1. A method for generating a customized robot model using artificial intelligence, the method being performed by an electronic apparatus and comprising:
receiving data including information regarding a robot model to be generated by a user, wherein the data includes data in two or more forms among a text form, an image form, an audio form, and a video form;
generating a plurality of robot models that conform to the information based on an artificial intelligence multimodal model;
evaluating physical properties of the generated robot models using GNN (Graph Neural Network) and PINN (Physics-Informed Neural Network);
selecting a customized robot model that most conforms to the information among the generated robot models based on the evaluation;
training the customized robot model through reinforcement learning; and
outputting the customized robot model in a universal robot data format.

2. The method of claim 1, wherein the receiving the data includes receiving data in a form of a prompt for an artificial intelligence language model.

3. The method of claim 1, wherein the generating the robot models includes considering a past search history of the user.

4. The method of claim 1, wherein the reinforcement learning includes policy-based reinforcement learning using PPO (Proximal Policy Optimization) algorithm.

5. The method of claim 1, wherein the reinforcement learning includes parallel multi-agent reinforcement learning.

6. The method of claim 1, wherein the training the customized robot model through reinforcement learning includes training the customized robot model with data based on domain randomization.

7. The method of claim 1, further comprising:
receiving feedback on the training from the customized robot model and training the artificial intelligence multimodal model.

8. The method of claim 1, further comprising:
normalizing an image of the customized robot model using a ViT (Vision Transformer) model.

9. An electronic apparatus comprising:
one or more processors; and
one or more memories storing at least one instruction executable by the one or more processors,
wherein the one or more processors are configured to, by executing the at least one instruction:
receive data including information regarding a robot model to be generated by a user, wherein the data includes data in two or more forms among a text form, an image form, an audio form, and a video form;
generate a plurality of robot models that conform to the information based on an artificial intelligence multimodal model;
evaluate physical properties of the generated robot models using GNN (Graph Neural Network) and PINN (Physics-Informed Neural Network);
select a customized robot model that most conforms to the information among the generated robot models based on the evaluation;
train the customized robot model through reinforcement learning; and
output the customized robot model in a universal robot data format.

10. A non-transitory computer-readable recording medium storing at least one instruction that, when executed by one or more processors, causes the one or more processors to perform operations, wherein the operations comprise:
receiving data including information regarding a robot model to be generated by a user, wherein the data includes data in two or more forms among a text form, an image form, an audio form, and a video form;
generating a plurality of robot models that conform to the information based on an artificial intelligence multimodal model;
evaluating physical properties of the generated robot models using GNN (Graph Neural Network) and PINN (Physics-Informed Neural Network);
selecting a customized robot model that most conforms to the information among the generated robot models based on the evaluation;
training the customized robot model through reinforcement learning; and
outputting the customized robot model in a universal robot data format.
